(19) United States
(12) Patent Application Publication
(10) Pub. No.: US 2019/0066239 A1
(43) Pub. Date: Feb. 28, 2019

(54) System and method of kitchen communication

(71) Applicant: Prince Castle LLC, Carol Stream, IL (US)

(72) Inventors: Paul Touchette, Naperville, IL (US); Loren Veltrop, Chicago, IL (US)

(73) Assignee: Prince Castle LLC, Carol Stream, IL (US)

(21) Appl. No.: 16/110,491

(22) Filed: Aug. 23, 2018

Related U.S. Application Data
(60) Provisional application No. 62/549,251, filed on Aug. 23, 2017.

(51) Int. Cl. G06Q 50/12; G06Q 20/20; H04L 29/08; G06K 9/00; G06T 19/00; G01J 5/02; F25D 29/00; G01N 21/94

(52) U.S. Cl. CPC G06Q 50/12; G06Q 20/202; G06Q 20/203; H04L 67/12; G06K 9/00671; G06F 3/0481; G01J 5/025; F25D 29/00; G01N 21/94; G06K 2209/17; G06K 9/00288; G06T 19/006

(57) ABSTRACT

Systems and methods of kitchen communication include a restaurant internet of things (IOT) system. The IOT system communicatively connects to a plurality of pieces of food treatment equipment in a kitchen. A digital reality (DR) server is operable to store or access stored graphical user interface (GUI) data for each piece of food treatment equipment. A DR headset is in communicative connection with the DR server. The DR headset is operable to project the GUI for each of the plurality of pieces of food treatment equipment in a manner for viewing by a user of the DR headset at a location relative to each of the pieces of food treatment equipment.

### CROSS-REFERENCE TO RELATED APPLICATION

The present application claims priority of U.S. Provisional Patent Application No. 62/549,251, filed on Aug. 23, 2017, the content of which is hereby incorporated herein by reference in its entirety.

### BACKGROUND

The present disclosure relates to computer-implemented systems and methods, graphical user interfaces, and graphical user interface or virtual objects in the context of a restaurant or food service setting. More particularly, the present disclosure relates to virtual reality, augmented reality, and/or mixed reality systems and objects in combination with a restaurant or food service setting to provide new interactions with food preparation and service equipment as well as workflows and key operation metrics within a food preparation environment.

Current restaurant or food preparation service facilities rely on a large number of specialized pieces of equipment to cool, heat, or otherwise treat constituent components of food products, for example, sandwiches. Refrigerators or freezers hold constituent foods prior to treatment to maintain quality and avoid spoilage. Deep fryers, toasters, steam and/or microwave heaters, and grills provide some examples of component food treatment devices which are used to heat or otherwise treat the component foods prior to assembly of the food product. Still further holding devices may hold the treated component foods in a stasis condition. Still other areas of food service facility may include beverage or other dispensers, a customer service ordering/delivery counter, a customer order staging area, and areas for preparation of hot and/or cold food products. Such stations and/or equipment, as well as others, are commonly found in quick service restaurants (QSR) or institutional or commercial food preparation facilities. Currently in a restaurant, an employee undergoes two weeks of training on the twenty or more different pieces of equipment in the kitchen. Many of these pieces of equipment have completely different user interfaces and input or operational workflows for the employee to learn. The normal employment duration in the QSR industry is approximately six months. QSR restaurants typically employ twenty to thirty employees per store at any given time. With approximately 150,000 QSR stores in operation and increasing in number, expended time and resources to employee training is significant.

U.S. Patent App. Pub. No. 2017/0020332 discloses a method for operating a food processor in which information for operation or preparation is projected onto the device for the user. The information may actually be projected onto the device by a wearable image generation device worn by the user or may be projected towards the user's eyes to appear superimposed on the device.

U.S. Patent App. Pub. No. 2018/0032125 discloses a device having a display that presents a virtual reality object to control another separate device. A coffee table has a top, flat surface on which no real-world, physical objects are currently placed. An augmented reality headset presents one or more control sets on this top surface for controlling an oven in a kitchen adjacent to the room with a temperature dial and off button.

U.S. Patent App. Pub. No. 2018/0101608 discloses a method for assisting a user in orchestrating preparation of a meal based on recipes. The recipes include instructions for how to complete a dish in a given work order. The disclosed method device includes the projection of a movie and/or an image on a wall, fridge, or any other similar surface. The communicated information include temperatures of stoves or ovens overlaid where the appliance is within the kitchen environment.

U.S. Patent App. Pub. No. 2016/0307459 discloses techniques for interactively training a user in performing a predetermined task related to food safety or food quality. A series of steps are visually presented on a digital display in a predetermined order to direct the user through a process of performing a task. The digital display may be the lens of a wearable device in which information is directed in the line of sight of the user and may project multimedia over real world, physical objects.

Many restaurant or food preparation service facilities are presented with similar challenges of integrating a large variety of equipment and processes, such equipment frequently being provided by numerous manufacturers. The user interfaces and graphical user displays associated with each of these devices or used in relation to various stations as described above can result in a setting where information displays are different/inconsistent/specialized to each piece of equipment and each manufacturer of the equipment. In food preparation facilities, physical space is often held at a premium and a tradeoff must frequently be made between device volumetric footprint and the size and/or complexity of the user interface and information displays associated with devices. Frequently, the content of the information presented and/or the size and resulting visibility of the content presented must be limited to meet the size constraints. Therefore, new solutions in food preparation equipment information conveyance can improve facility floor plans and physical constraints while opening new possibilities for personnel workflow, training, and tasks.

### Brief Disclosure

In an exemplary embodiment of a kitchen communication system, the system includes a restaurant internet of things (IOT) system, which may exemplarily be implemented as a kitchen communication network. The IOT system communicatively connects to a plurality of pieces of food treatment equipment in a kitchen. The food treatment equipment exemplarily includes thermal treatment equipment that chills, freezes, bakes, fries, grills, broils, toasts, or holds in a stasis environment, one or more pieces of food. Food treatment equipment may further include equipment that dispenses or performs another operation on a food or a food component, for example, condiment dispensing which may include sauce condiments and produce condiments. A digital reality (DR) server is operable to store or access stored graphical user interface (GUI) data for each piece of equipment of the plurality of pieces of food treatment equipment. The GUI data includes a GUI for each category of the plurality of pieces of food treatment equipment. A DR headset is in communicative connection with the DR server. The DR headset is operable to project the GUI for each of the plurality of pieces of food treatment equipment in a manner for viewing by a user of the DR headset at a location relative to each of the pieces of food treatment equipment or at a remote location such as a customer serving area.

In exemplary embodiments, the location relative to each of the pieces of food treatment may include a position across at least one void in the piece of food treatment equipment. The location relative to each of the pieces of food treatment may further include a position across the at least one void and at least one structure portion of the piece of food treatment equipment. Each of the GUI for each of the plurality of pieces of food treatment equipment may include common portions across each piece of food treatment equipment. The plurality of pieces of food treatment equipment may include different configurations of the same equipment type. The plurality of pieces of food treatment equipment may include a refrigerator which includes at least one camera in an interior of the refrigerator. The refrigerator may be communicatively connected to the DR server through the restaurant IOT system and the DR server operates the DR headset such that the GUI for the refrigerator overlaid across at least a portion of the refrigerator presents images of the interior of the refrigerator acquired by the at least one camera. The plurality of pieces of food treatment equipment may include a griddle and the DR server operates the DR headset such that the GUI for the griddle presents visual indications of a plurality of food cooking zones on the griddle surface and further visually presents an indication of griddle temperature.

In exemplary embodiments, the kitchen communication system may include a point of sale system (POS) communicatively connected to the restaurant IOT system. The point of sale system receives customer orders. The restaurant IOT system receives and tracks inventory management data from the plurality of pieces of food treatment equipment. The DR server operates the DR headset such that the GUI associated with each of the plurality of pieces of food treatment equipment presents customer order data and inventory management data associated with the piece of food treatment equipment. The DR server may receive the customer orders and operate the DR headset to present a GUI at a specified order assembly location that includes visual indications of the food products required to complete assembly of a customer order of food products. The DR server may receive the customer orders and operate the DR headset to present a GUI at a specified food assembly location with visual guidance to assembly a particular food product in accordance with the customer orders.

In further exemplary embodiments of the kitchen communication system, the DR headset may include an infra-red (IR) emitter. The DR headset may measure a temperature of a surface to which the IR emitter is directed and the DR headset presents the measured temperature in a GUI presented by the DR headset associated with the surface to which the IR emitter is directed. The DR headset may further include an ultraviolet (UV) emitter. The DR headset may provide a GUI associated with a surface to which the UV emitter is directed. The DR headset may operate the GUI to present an indication of detected UV light from the UV emitter that is reflected from the surface. The DR headset may operate to capture an image of an employee. The DR headset and DR server may operate to identify the employee in the captured image. The DR headset may operate to present a GUI in a location associated with the employee to present employee data in the GUI. An RFID tag may further be associated with the employee. The DR headset may determine the employee at least in part from a signal from the RFID tag.

In an exemplary embodiment of a method of kitchen communication, a customer order is received at a point of sale (POS) system. The customer order is communicated from the POS system to a restaurant internet of things (IOT) system that is communicatively connected to a plurality of pieces of food treatment equipment in a kitchen. The customer order is provided from the POS system to a digital reality (DR) server. The DR server operable to store or access stored graphical user interface (GUI) data for each piece of equipment of the plurality of pieces of food treatment equipment. The GUI data includes a DR GUI for each of the plurality of pieces of food treatment equipment. A DR headset is operated in communication with the DR server to provide at least a portion of the customer order to the DR headset. A DR GUI is presented by the DR headset in an apparent location relative to an associated piece of food treatment equipment. The DR GUI presents at least the portion of the customer order.

In further exemplary embodiments of the method of kitchen communication, a current inventory of a food product may be determined by the associated piece of food treatment equipment. The current inventory of the food product may be communicated to the restaurant IOT system. The current inventory of the food product may be communicated to the DR headset through the DR server. The current inventory of the food product may be presented in the DR GUI. An image may be captured with a camera associated with the DR headset. The DR server may identify a piece of food treatment equipment of the plurality of pieces of food treatment equipment in the image. The DR GUI may be selected from the DR GUIs for each of the plurality of pieces of food treatment equipment based upon the identification of the piece of food treatment equipment in the image. Identification of the piece of food treatment equipment may further include an identification of a type of food treatment equipment of the identified piece of food treatment equipment. Each DR GUI associated with a piece of food treatment equipment of the same type of food treatment equipment includes a same DR GUI. The type of food treatment equipment may be a holding bin. A void may be identified in the piece of food treatment equipment from the image captured with the camera associated with the DR headset. The apparent location relative to the associated piece of food treatment equipment is across the identified void in the piece of food treatment equipment. At least one structure portion of the piece of food treatment equipment may be identified in the piece of food treatment equipment from the image captured with the camera associated with the DR headset. The apparent location relative to the associated piece of food treatment equipment is further across the identified at least one structure portion of the piece of food treatment equipment. The DR GUI for each of the plurality of pieces of food treatment equipment may further include at least some common GUI features across all of the DR GUIs for the plurality of pieces of food treatment equipment.

### BRIEF DESCRIPTION OF THE DRAWINGS

FIG. 1 depicts an exemplary embodiment of a digital reality (DR) enabled food preparation setting.

FIG. 2 depicts an exemplary embodiment of a communication system within a DR enabled food preparation setting.

FIG. 3A depicts an exemplary view of a holding bin device as may be used in a DR enabled food preparation setting.

FIG. 3B depicts a DR graphical user interface (GUI) that the user sees overlaid on the front of the holding bin device.

FIG. 3C depicts a DR GUI overlaid on the front of the holding bin device.

FIG. 4 depicts an additional exemplary embodiment of a DR GUI as may be presented on the front of a refrigerator.

FIG. 5 depicts an exemplary embodiment of a DR GUI overlaid on food product preparation station.

FIG. 6 depicts an exemplary embodiment of a DR GUI overlaid on a grill top.

FIG. 7 depicts an exemplary embodiment of a DR GUI overlaid on an order staging area.

### DETAILED DISCLOSURE

Systems and methods as disclosed herein relate to the integration of digital reality (DR) into food preparation devices, settings and methods. As used in the present disclosure, digital reality is exemplarily used to refer to any of a variety of systems and/or methods in which perceptible digital content is presented to a user in an immersive manner. Three examples of digital reality platforms which may be used in embodiments as described herein include virtual reality (VR), augmented reality (AR), and mixed reality (MR). It will be understood that any of these technologies may be generally referred to herein as digital reality (DR) and embodiments of the systems and methods as disclosed herein may be carried out in any VR/AR/MR platforms unless otherwise specified in the present disclosure. All forms of DR use a combination of visual, audio, and haptic feedback and interaction to provide use perceptible and intractable digital content to the user. U.S. Pat. Nos. 8,264,505 and 9,529,424 disclose exemplary embodiments of DR systems and are both incorporated herein by reference in their entireties. While not necessarily the case, frequently the systems use a headset to provide visual and/or audio content to the user, although, other embodiments may use projectors or other visual display systems. U.S. Patent Application Publication No. 2016/0097929 discloses exemplary embodiments of a headset and is incorporated by reference in its entirety.

Virtual reality (VR) immerses the user in the perceived content. Typically, the more than a user is isolated from the real environment, the immersion and resulting perception of the digital content is increased. Therefore, virtual reality is characterized by this isolation and immersion. Commercially available examples of this are characterized by PlayStation VR and the Oculus Rift.

Augmented reality (AR) keeps the user's perception of the real world surrounding the user but adds digital information/content/data to the perceived world. AR typically uses see-through glasses, for example, Google glass from Google, the Meta2 by Meta Company, or Pokemon Go. Mixed reality (MR) is used herein to describe a combination of VR and AR content and perception. Like AR, MR keeps the user perceiving the real world, for example through clear glass glasses while fixing digital perceivable content at physical locations in connection with the area around the user. Embodiments of MR include the forthcoming Microsoft Hololens. With MR, the digital content can be fixed in physical relation to the surrounding real world and perceived by a user or users of the MR system.

It will be recognized that the lines between VR/AR/MR are not precisely defined and therefore the umbrella term of digital reality (DR) is used herein. A variety of exemplary embodiments will be described herein in an illustrative manner and a person of ordinary skill in the art will recognize further embodiments within the present disclosure in view of these examples.

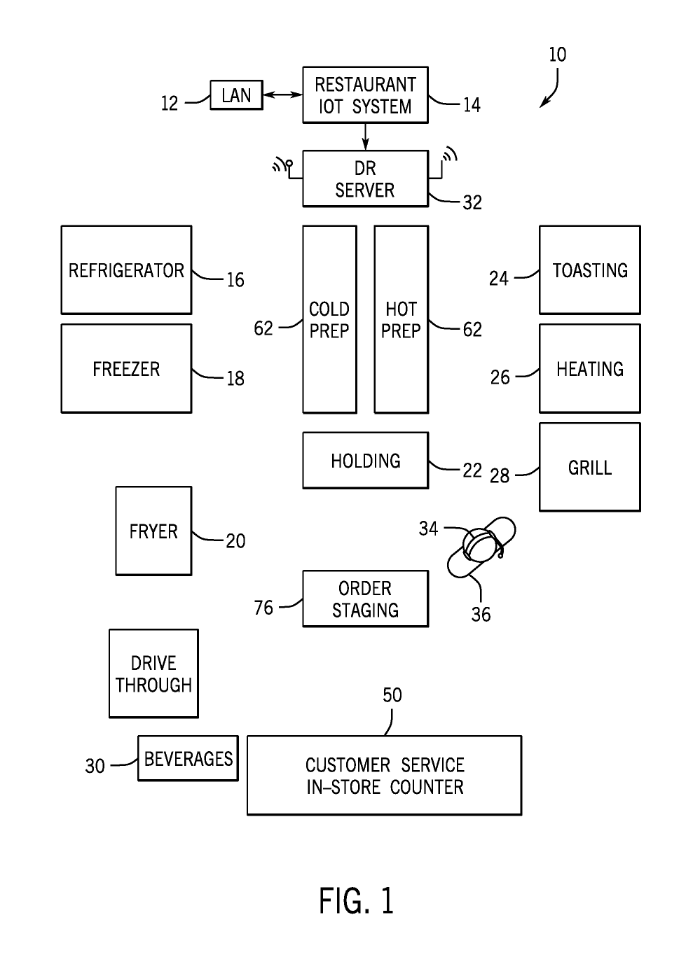

Exemplary embodiments of the kitchen communication systems and methods as disclosed herein can be used to supplement and/or replace the user interfaces and/or graphical displays associated with individual food preparation devices. In exemplary embodiments, a DR headset device is communicatively connected to a computing system associated with the preparation facility. FIG. 1 depicts an exemplary embodiment of a DR enabled food preparation facility 10 which includes a variety of food preparation devices and/or stations, a variety of which may be computer integrated or controlled devices communicatively connected through a local area network (LAN) 12 (or wide area network depending upon network arrangement) to a restaurant internet of things (IOT) system 14. The LAN may be implemented in wired or wireless to both communication platforms. The restaurant IOT system 14 communicates through the LAN 12 to each of the communicatively connected devices which may include, but is not limited to a refrigerator 16, a freezer 18, a fryer 20, a holding bin device 22, toasters 24, heating devices 26, a grill 28, or beverages dispensers 30. Each of these devices may exemplarily provide operation, use, and setting data to the restaurant IOT system 14. In exemplary embodiments, the restaurant IOT system 14 is exemplarily connected to a DR server 32. The DR server 32 is exemplarily communicatively connected to a DR headset 34 worn by a user 36. In an exemplary embodiment, the DR headset 34, while not depicted in detail, may include a pair of glasses that project light onto the retina of a user, one or more cameras to obtain information regarding the real environment visually perceived by the user, and a computer that operates these and other systems of the DR headset 34 and further communicates with the DR server 32. In an exemplary embodiment, the DR headsets 34 as described in further detail herein operate to locate DR GUIs relative to various pieces of equipment in the food preparation setting. In still further exemplary embodiments provided herein, new forms of training, guidance, or management are enabled through the DR GUIs and environment provided by the DR headsets 34.

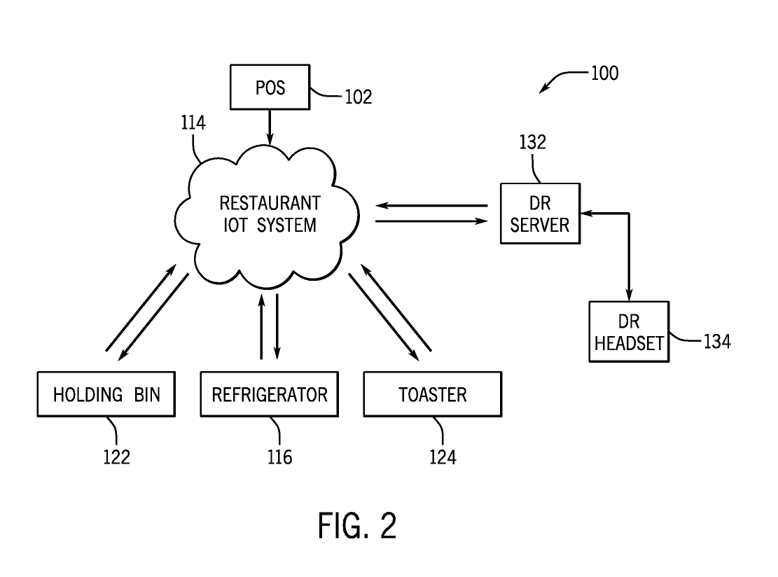

FIG. 2 is a system diagram of a kitchen communication system 100 as will be described in further detail herein. The kitchen communication system 100 generally includes a point of sale (POS) system 102. The POS system 102 is communicatively connected to a restaurant IOT system 114. Custom orders are exemplarily received at the POS system 102. The interface to the POS system 102 may be a register computer operated by a cashier, a drive-through ordering system, or an online ordering system, or any other point of sale order entry arrangement as will be recognized by a person of ordinary skill in the art in view of the present disclosure. The POS system 102 take in the customer order which specifies one or more food items which require preparation and/or assembly. In exemplary embodiments, one such food item may be a cheeseburger sandwich. The POS system 102 can provide this order information to the restaurant IOT system 114. The POS system 102 may therefore include a DR GUI with which the user interacts to enter a customer's order into the POS system 102.

The restaurant IOT system 114 is exemplarily a communication network and either locally or remotely located server system that manages communication between various components in a kitchen. The restaurant IOT system 114 is exemplarily a cloud-computing enables system whereby data collection and serving of data is handled by one or more processors and/or servers. The restaurant IOT system 114 exemplarily receives and stores the customer order (e.g. from the POS system 102), receives or identifies the components of the customer order and then directs the order information and any customization or further instructions regarding various components of the customer order to the devices in the kitchen and then handle or process that component or customization. The restaurant IOT system 114 is exemplarily remotely located from the kitchen, although in other exemplary embodiments, the processors and/or servers which carry out the functions of the restaurant IOT system 114 as described herein may also be located locally within the kitchen or restaurant facility.

The restaurant IOT system 114 is exemplarily communicatively connected to the various communication enables pieces of restaurant equipment, and more specifically to various pieces of food treatment equipment. As non-limiting examples as provided herein, these pieces of food treatment equipment include holding bins 122, refrigerators 116, and toasters 124. While the restaurant IOT system 114 provides construction and control messages or commands to these various pieces of food treatment equipment, the restaurant IOT system 114 further exemplarily receives information back from these and other similar devices, for example related to device operation, current and/or used inventory or other operational parameters, including an identification of the device.

The restaurant IOT system 114 is further communicatively connected to the DR server 132 which provides for coordination and communication between the restaurant IOT system 114 and the DR headset 134 as described above and as will be described in further detail herein. It will be recognized that in embodiments, the POS system 102, the restaurant IOT system 114, and the DR server 132 may exemplarily be implemented across one or more processors and/or computing system, or may be provided in various network, distributing and/or cloud-computing arrangements, while the functions, operations, and communications as described herein are performed as described herein.

The POS system 102, which may include user interface provided in a DR GUI presented by the DR headset 134 communicates the customer order to the restaurant IOT system 114, which exemplarily identifies the required components of the customer order. Once broken into required components, these instructions may be provided directly to the pieces of food treatment equipment (e.g. holding bin 122, refrigerator 116, and/or toaster 124), as well as to the DR server 132 to facilitate or update the operation of the DR headset 134 to operate to provide one or more DR GUIs as described in further detail herein. In automated or semi-automated kitchen systems, the pieces of food treatment equipment or other preparation devices, including, but not limited to beverage dispensers or condiment dispensers which may also be used within a kitchen system, those devices may, upon the instructions from the restaurant IOT system 114 operate to carry out operation, processing, or dispensing of portions of the food order. Meanwhile, the restaurant IOT system 114 provides this information to the DR server 132 for coordination with DR headset 134 such that the DR headset 134 operates to present DR GUIs in locations and association with the pieces of equipment to reflect their operation, use, status, and interrelated statuses as described in further detail herein. Each of the pieces of equipment communicatively connected to the restaurant IOT system 114 can provide information back to the restaurant IOT system 114, for example relating to completion of the progress of customer orders, remaining inventory, and inventory use. This information can be used by the restaurant IOT system 114, for example in combination with the DR server 132 to provide statuses, updates, and instructions for presentation at the DR GUIs created by the DR headsets 134 in the embodiments as described in further detail herein.

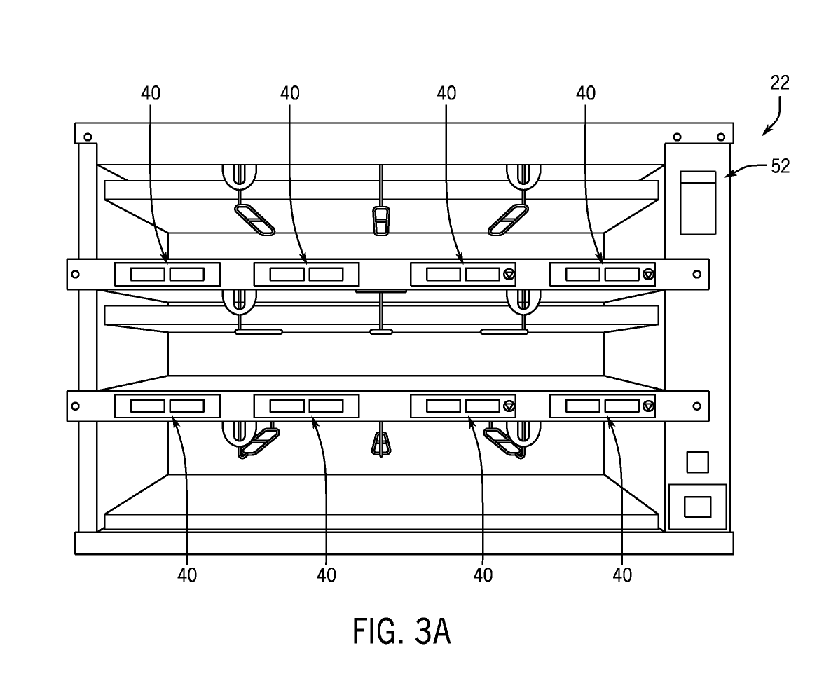

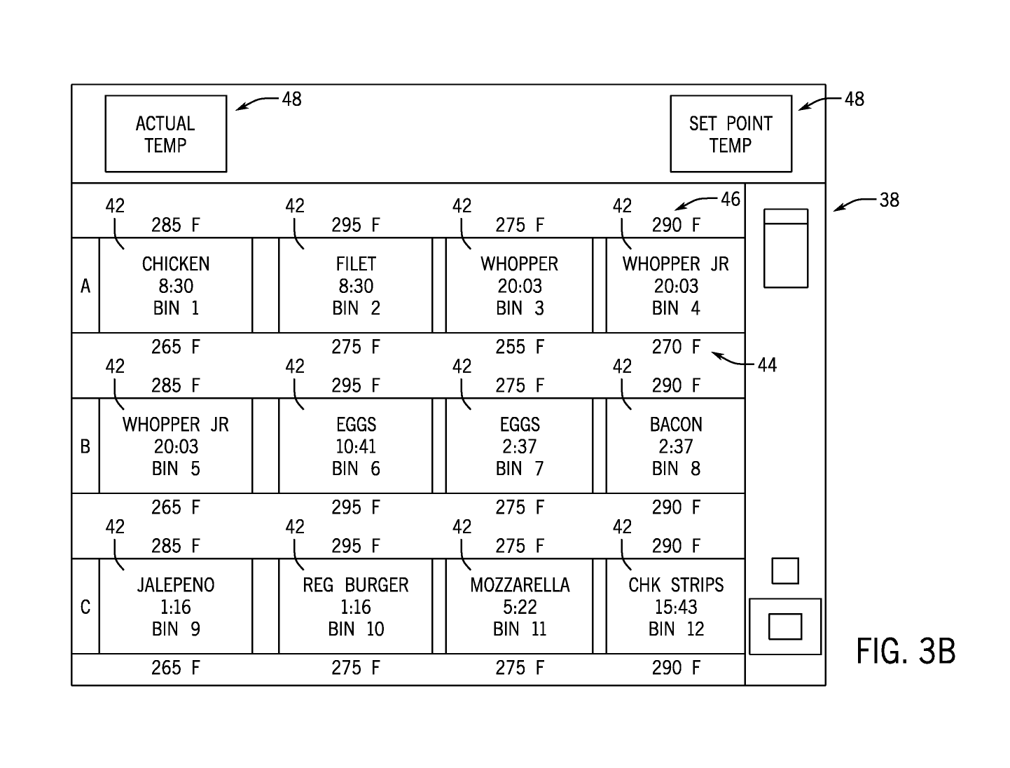

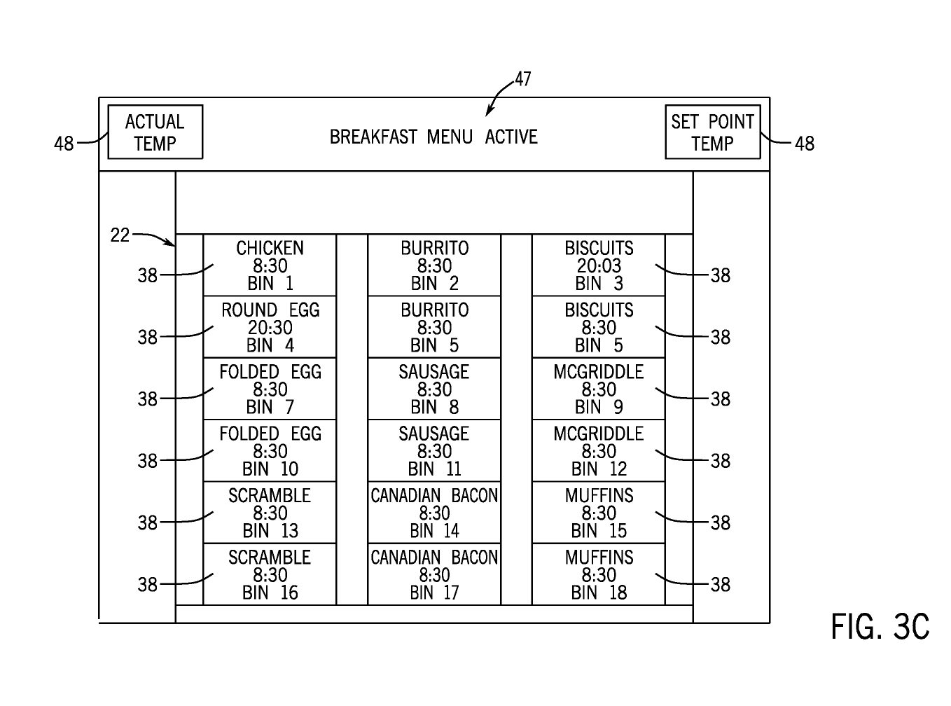

FIG. 3A depicts an exemplary view of a holding bin device 22 as may be used in a food service preparation setting. The holding bin device 22 exemplarily includes openings or voids 41. The voids 41 in the holding bin device are exemplarily defined by the outward structure 43 of the holding bin device 22, exemplarily provided by the exterior housing of the holding bin device 22. The holding bin device 22 exemplarily includes LCD displays 40 mounted to the outward structure 43. The holding bin device 22 exemplarily includes the voids 41 to receive trays of various food products therein (not depicted). The holding bin device 22 operates to maintain environmental conditions (e.g. temperature, humidity) about the food products in the trays to preserve the quality of the food products until use.

FIG. 3B exemplarily depicts a DR GUI 38 that the user sees in the DR environment provided by the DR headset 34. The DR GUI 38 is overlaid at a location in front of the holding bin device 22. Rather than limiting the graphical display content to LCD displays 40, the DR GUI 38 is located at a position in front of the entire holding bin device 22. The DR GUI 38 provides a larger and more readable presentation of information and also provides a further presentation of more information, including a detailed and intuitive description of each of the food items held in each position of the holding bin. The DR GUI 38 may include a plurality of sub-GUI's or objects. In further examples, as will be described herein, each of these sub-GUI's or objects may be presented and operated as independent DR GUIs 38. However, for the purpose of description related to FIG. 3B, these will be described as identification objects 42. The identification objects 42 are exemplarily located in virtual space relative to an associated opening or void 41 in the holding bin device 22.

The identification objects 42 are positioned at locations relative to identified voids 41 in the holding bin device 22. In an exemplary embodiment, the identification objects 42 are located in alignment with the voids 41 of the holding bin device 22. In another exemplary embodiment, the identification objects 42 are located across at least a portion of the voids 41 and at least a portion of the outward structure 43. In the DR environment provided by the DR headset, this enables flexibility in the manner in which the DR GUI 38 is presented relative to the holding bin device 22. In one exemplary embodiment, each identification object 42 of the DR GUI 38 provides both the identification of the food item held within a particular position (e.g. void 41, or void portion) of the holding bin device 22 as well as an elapsed time that the food items therein have been held. In still further embodiments, it is possible that the identification object 42 provides a count or estimated count of remaining food items in that space of the holding bin device. The identification of the food item, the elapsed time that the food item has been held, and the remaining count of food items may all be provided for display in the identification object 42 from the holding bin device or the restaurant IOT system as described above. Because the identification object 42 only exists in virtual space, the user may reach through the identification object 42 to obtain the food item held within that position. In exemplary embodiments, the identification object 42 may be transparent or translucent to aid in this action by the user. In this manner, greater information presentation space may be achieved while keeping the same or reducing the volumetric footprint of the holding bin device.

Additionally, the DR GUI 38 uses the real estate of such user interface to present both actual temperatures 44 and setpoint temperature 46 over portions of the structure of the holding bin device that previously was not provided with any graphical display. Again, this increases the visibility of this information from a greater distance. In a further example, the DR GUI 38 may extend to the entirety of the area of the holding bin, or in embodiments may extend beyond the holding bin device. The DR GUI 38 further includes button objects 48, for example, an actual temperature setting button or a set point temperature button which may be virtually interacted with within the mixed reality environment to adjust settings or control operation of the holding bin device. These button objects may be used or made available in place of physical touch-sensitive graphical display 52 as may be found on the physical holding bin device 22. With the provision of button objects, a manager or other responsible user may interact with the device through the button objects at a distance rather than needing to be physically in contact with the holding bin device in order to exemplarily use the touch-sensitive graphical display 52. Thus, workflows may be improved with more efficient adjustment and control of the holding bin device.

FIG. 3C depicts another exemplary arrangement of DR GUIs 38. In the embodiment depicted, multiple DR GUIs 38 are presented, each representing a location on the holding bin device. As noted above, some embodiments, the DR GUIs 38 are aligned with the voids in the holding bin device as defined between the structural components of the holding bin device. In another embodiment, a single DR GUI 38 may extend over a portion or the entirety of the holding bin device with regions of the DR GUI 38 transparent or opaque to highlight the DR GUIs operated as identification objects or control button objects 48. Status messages 4, for example, “Breakfast Menu Active” may be presented at a location in alignment with a structural portion of the holding bin device, or at a location proximate, but adjacent the holding bin device as depicted.

In exemplary embodiments, the DR GUI may be defined at locations relative to the physical environment. These locations may be generally static, although may be adjustable within the DR controls. In such an embodiment, the DR server may operate to store the DR GUIs and the specified locations thereof relative to the physical environment. Further in such embodiments, as described above, communication may be provided between the piece of equipment to the restaurant IOT system and onto the DR server so as to provide the measurement and conditions of the particular piece of equipment to be presented on the DR GUIs. This may include measure temperature, set temperature, food inventory counts as determined by the piece of equipment or as determined by the POS system or the restaurant IOT system. In such an embodiment, the DR server operates to control the location and content of the DR GUIs and transmits the same to the DR headsets for projection to the user. The DR headsets exemplarily include a camera which provides image information regarding the physical environment to the DR server and which the DR server back to the DR headset the DR GUIs and other digital content for presentation to the user through the DR headset. In embodiments, the DR server may use image recognition processing and techniques to identify various locations in the physical environment and to associate the location of the DR GUIs therein. In another exemplary embodiment, the image recognition and processing is performed exemplarily at the DR headset. Image processing techniques, for example, edge detection or image recognition may be used to identify the void or structure portions of a relevant piece of equipment and to locate the associated DR GUIs relative to these identified features of the piece of equipment.

The DR server, as described above, may either be provided with an identity of particular holding bin or other equipment, within the kitchen, including a device identification and configuration, for example from the restaurant IOT system. This may exemplarily be provided in the form of a serial number, part number, and provided in a setup procedure to connect the piece of equipment the restaurant IOT system. In another embodiment, the DR server may, through image analysis of images captured from one or more DR headsets, identify the type and model of holding bin device present in the food service preparation area and provide the same DR GUI 38 at a location overlaid relative to the front of the holding bin device 22, although adjusted or manipulated to account for the physical and operational differences of that particular device. In such embodiments, a consistent DR GUI 38 may be presented to users independent from the make or model of the underlying device. Differences in the make or model of the piece of equipment may occur if devices were purchased from different manufacturers/vendors or if a legacy model of the piece of equipment is still in use. Presentation of a common DR GUI 38 across each of these types of devices can provide efficiency to the user as the user learns and becomes accustomed to a single user interface arrangement and operation and uses such interface to interact with any of a plurality of different types of devices. Additionally, consistencies in layout, operation, and use between graphical user interfaces for various different types of food treatment equipment can be made consistent within the DR ecosystem independent of the make or model of the devices themselves, or the form of the devices. This also enables consistent and/or specialized graphical user interfaces to be developed and used across multiple locations of the same restaurant. This may help users to integrate into working at multiple food service facilities.

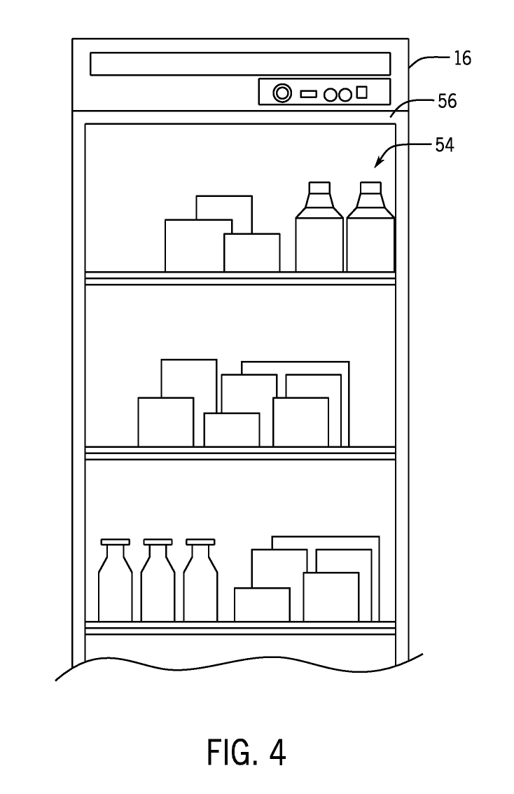

FIG. 4 depicts an additional exemplary embodiment of a graphical user interface as may be presented in a DR environment. A DR GUI 54 is presented in the DR environment that is located relative to a portion of the structure of the refrigerator (e.g. relative to the door 56 of the refrigerator 16). The restaurant IOT system, as described above, may exemplarily receive image information from one or more cameras located within the refrigerator 16 and the restaurant IOT system provides this image information to the DR server which controls the content of the DR GUI 54 and provides that information to one or more DR headsets such that the image information from the cameras in the refrigerator 16 is presented in the DR GUI 54 so that the user can see the contents of the refrigerator 16 without opening the solid door 56. This enables both more energy efficient construction of the door 56 including the user of opaque insulative materials. It also encourages more energy efficient use of the refrigerator by users as users are not required to open the door 56 in order to see the contents stored therein. Additionally, workflows are also improved as a user need not walk over to the refrigerator 16 in order to view the contents stored therein. This may be particularly helpful when multiple refrigerators are located within a food preparation setting and users may walk to and open the appropriate refrigerator correctly in a first try.

Additionally, while graphical displays have become more energy efficient, embodiments of the systems as presented herein remove the need for physical graphical displays eliminating the need to power and operate these graphical displays on each device. Additionally, by providing graphical user interfaces in the DR environment, new food treatment equipment can be designed in a more useful and efficient manner for the purpose of the food treatment rather than design consideration required to accommodate graphical displays and graphical user interfaces. In still further exemplary embodiments, graphical displays in the DR environment can be used with legacy or older food service equipment to provide a more sophisticated user interface or control options.

In still further exemplary embodiments, sale/check-out/ordering kiosks or computers may be provided as DR GUIs within the DR environment to provide more efficient use of the customer service or in-store counter space 50 (FIG. 1). With the removal of physical point of sale computer or kiosks, the physical space of the customer service in-store counter can be flexibly used for ordering or food delivery purposes depending upon present demands rather than fixing the use or purpose of such areas by placement of physical devices.

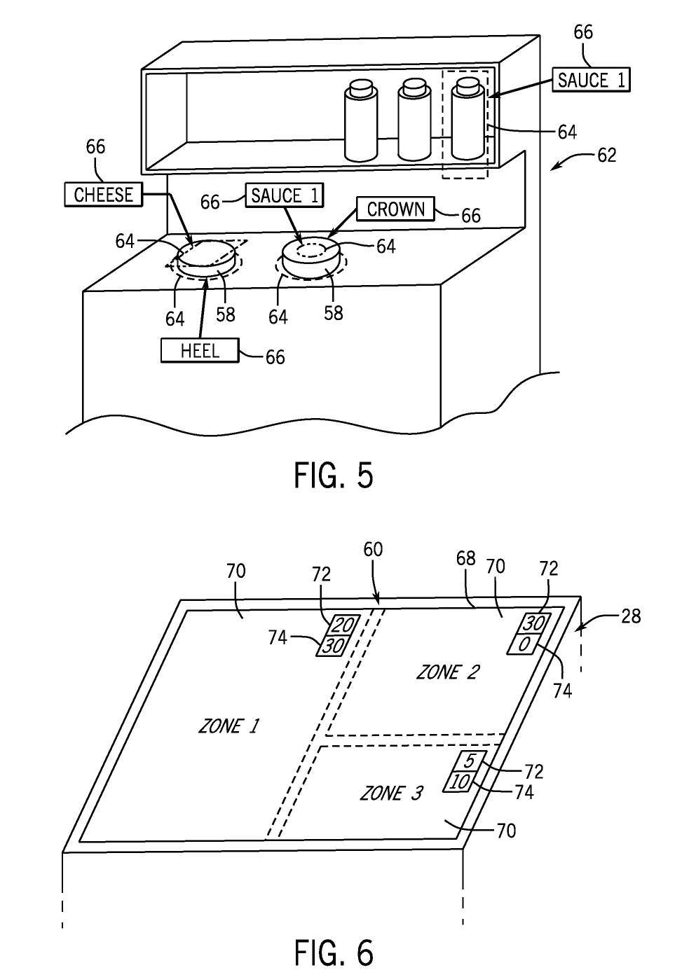

FIG. 5 depicts an exemplary embodiment of a food product preparation station 62. In an exemplary embodiment, in the DR environment, the user is presented with one or more DR GUIs 64 which are located relative to the food product preparation station 62 and to any identified food components 58 during the assembly of the customer order. In an exemplary embodiment, image recognition processing in the DR headset and/or in the DR server in communication with the DR headset may identify the existing food components 58 and locate any DR GUIs 64 relative to the food components 58. The presentation in the DR environment may be coordinated with the restaurant IOT system 14 (FIG. 1) such that the user is further informed and instructed to assemble the required food products to fulfill the current and pending orders. In an exemplary embodiment, a combination of DR GUIs that include symbols, pictures, and/or text may be presented to the user in the DR environment. In an example, the DR GUIs 64 include outlines to identify a place for the user to position two halves of a roll or bun for construction of a sandwich. A combination of color, graphics, and/or text (see “heel” and “crown”) inform the user, for example, DR GUIs in the form of labels 66. As depicted in FIG. 5, the user has already positioned these food components 58 of the sandwich in these labeled DR GUIs 64. The user is further presented with the next steps in the construction of the sandwich, for example, one DR GUI 64 and label 66 identifies the placement of cheese on the heel of the bun and “Sauce 1” on the crown on the bun. To further help guide the user, the DR environment highlights or draws the user's attention to the location of “Sauce 1” with a DR GUI 64 and label 66 as required to complete the sandwich. In exemplary embodiments, the color coding or transparency/opaqueness of the DR GUI 64 or labels 66 may help to indicate completed, current, and future assembly steps to the user. The DR GUI 64 may exemplarily be an outline around the identified object.

FIG. 6 depicts an exemplary embodiment of a grill top 60 as may be incorporated in grill 28 in FIG. 1. The grill surface 60 may be a heated surface of a metal which is exemplarily constructed to be smooth so as to facilitate cleaning and reduce accumulation of food. In an exemplary embodiment, in the DR environment, the user is presented with one or more DR GUIs 68 that overlay the grill surface 60. In the exemplary embodiment depicted in FIG. 6, a single DR GUI 68 overlays the grill surface 60, and the DR GUI 68 is divided into various sub-GUIs 70 as described herein. It will be recognized that these may instead be separate DR GUIs located relative to portions of the structure of the grill surface 60. The sub-GUIs 70 of the DR GUI 68 divide the area of the grill surface 60 into various cooking zones, for example for use in cooking different types of food in a manner which discourages or limits flavor or food cross-contamination during cooking. In a non-limiting embodiment, Zone 1 may be reserved for hamburgers, while Zone 2 is used for chicken and Zone 3 is used for cooking in conjunction with particularly flavorful sauces, for example, teriyaki, barbeque, buffalo, or siracha sauces. Additionally, inventory information is exemplarily provided in each of the sub-GUIs 70. The inventory information may include a current inventory count 72 of each type of protein (as exemplarily provided from the holding bin devices to the restaurant IOT system as described above). The sub-GUIs 70 may also present need counts 74 with requests or needs for additional protein. These requests or needs may be manually indicated from another foodservice worker through interaction with the restaurant IOT system or in other embodiments, may be based upon one or more of current orders received in the POS system, current inventory levels reported from the holding bins, and historical order information for that restaurant, including times and amounts of customer orders, While in FIG. 6 the inventory counts 72 and need counts 74 are presented as numerical counts, in other embodiments, this may also present an identification of the type of protein to be cooked e.g. 1:10 hamburger patties, 1:4 hamburger patties, chicken breast, chicken patty, or types of specialty flavorings.

In still further exemplary embodiments, the DR GUIs presented in the DR environment may be different for different users, for example, based upon the user's job, employment position, or assigned tasks. For example, a manager, working in the capacity as a manager may be presented with additional information within the DR environment, for example, to present information regarding the particular employees being managed. In an exemplary embodiment, based upon image recognition, facial recognition, or other identification systems, including, but not limited to RFID tags worn on the person of the employees, an employee may be identified and the DR environment of the manager includes information regarding the current tasks to which that employee is assigned, break information, or shift information. The manager, presented with this information in the DR environment, may use this information to better direct and manage the personnel.

In still further exemplary embodiments, the management DR environments may include a digital user interface in an easily accessible location with control for lighting, HVAC, or other mechanical systems which may have physical controls in remote or otherwise out of the way locations within the food service facility. These controls may be connected to the restaurant IOT system 14 through the DR server 32 (FIG. 1).

In a still further exemplary embodiment, the DR headset 34 may be equipped with additional cameras and/or functionality, including, but not limited to UV projection and/or sensing capability and/or IR projecting and/or sensing capability. In an exemplary embodiment, IR may be used to obtain measurements of temperatures, whether it is a grill surface 60, or food on the grill surface 60, a fryer oil temperature, or a freezer or refrigerator temperature. In exemplary embodiments that incorporate ultraviolet transmission and/or sensing of the reflection of these wavelengths, such systems may be used to evaluate cleanliness or bacteria sensing to aid in management sanitary review of the workspace.

In still further exemplary embodiments, for example in reference to FIG. 1, interaction between the restaurant IOT system 14, the DR server 32, and the various kitchen devices located throughout the food service location can be leveraged within the DR environment to improve workflows and notification to users within the DR environment. In an exemplary embodiment, the holding bin device 22, connected to the restaurant IOT system 14 may report that the holding bin device 22 has run low on or has run out of chicken tenders. Such an indication to the restaurant IOT system 14 may prompt an interaction with the DR server 32 so that a virtual notification is presented within the DR environment at the fryer 20 that more chicken tenders are needed. This prompts the user responsible for cooking chicken tenders in the deep fryer to take this action rather than another person tasked with packaging chicken tender to complete an order with noticing the absence or lack of chicken tenders and notifying the person operating the fryer to prepare more chicken tenders.

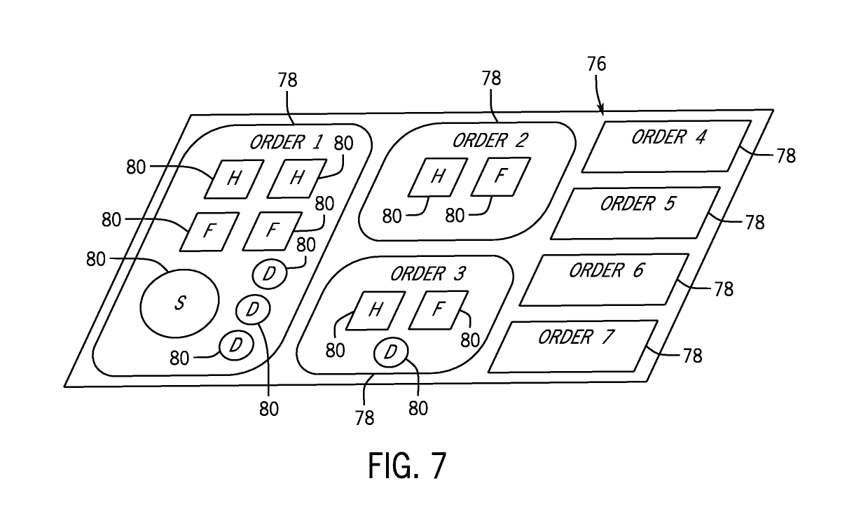

FIG. 7 depicts an exemplary embodiment of an order staging area 76. The order staging area 76 may exemplarily include DR GUIs 78 in the DR environment that outline a position for the assembly of each particular customer order and the remaining items needed to complete that order. As with the descriptions above, other embodiments may be implemented with a single DR GUI 78 located at the order staging area 76 with other sub-GUIs located therein. In the embodiment depicted in FIG. 7, three DR GUIs 78 are provided that are each located relative to a portion of the structure of the order staging area 76. The specific components of the customer order are presented as identification objects 80 within the DR GUI 78. In the exemplary embodiment, “Order 1” requires two hamburgers, two French fries, a salad and three drinks to complete the order. The size of the DR GUI 78 may adjust relative to the size of the customer order. In FIG. 7, “Order 2” requires a hamburger and French fries while “Order 3” requires a hamburger, French fries, and a drink.

In an exemplary embodiment, queued orders, but not currently being assembled may be indicated with DR GUIs 78 as well. As customer orders are assembled, completed, and delivered, these queued customer order DR GUIs 78 may expand to show the components of each customer order. In a further exemplary embodiment, a background color of the order may change color to indicate an elapsed time or a time relative to an order assembly time goal. In this manner, users are not only provided with a visual cue as to specific order assembly needs but are given a visual prompt as to which food items are required to complete an order and a position within the order in which such food items should be placed.

As previously noted, employee training is a considerable consideration in the operation of a restaurant, particularly a QSR store. The embodiments of computer implemented systems and methods as well as kitchen communication systems GUI's and interface objects as disclosed herein enable reductions in training by presenting additional guidance and information to workers and managers. Further exemplary embodiments promote worker and manager efficiency by enabling consistency across food treatment equipment of different types, makes, models, configurations, and manufacturers, as well as integration of legacy equipment into improved kitchen communication systems. Still further exemplary embodiments facilitate reconfiguration and improved use of kitchen space as well as the design and operation of food treatment equipment in more robust and energy efficient manners.

In exemplary embodiments, DR GUI's may be presented onto a device, in the air, or on another adjacent location, for example a wall or unused side of a piece of food treatment equipment. In one example, all holding bin food treatment equipment, even from different makes, models, or manufacturers, may prompt the virtual presentation of one or more of the same DR GUI's that are standardized to receive user inputs, and report relevant information to users to provide a consistent workflow across all of the pieces of holding bin food treatment equipment. Additionally, DR GUI's can be presented in sizes that are currently unavailable in the kitchen and food treatment equipment applications. The DR GUI's can be presented in sizes that cover an entirety of a face of a piece of food treatment equipment, or larger, DR GUI's can be presented in large formats on walls or in other previously unavailable spaces, for example floors, ceilings, or other areas above or below the working area in the kitchen. These DR GUI's can further be presented a reduced expense and energy efficiency compared to similarly sized and located physical graphical displays. Without incorporation of graphical displays and other user interfaces into the food treatment equipment itself, the food treatment equipment can be designed to be more compact with increased reliability with reduction or elimination of physical user interfaces. In another exemplary embodiment a DR GUI may include a virtual user interface with which a worker can interact to enter a customer's order into the POS.

In exemplary embodiments, the DR GUI may be overlaid onto a door of a refrigerator or other storage equipment, for example a cabinet or humidor. A similar DR GUI may also be overlaid onto a door of an oven or broiler. The DR GUI operates to present a view of the interior of the piece of equipment without opening the door. In equipment that maintains a temperature, humidity, or other environmental condition within the equipment, eliminating opening of doors enables more efficient maintenance of this controlled environment. In another exemplary embodiment, the food treatment equipment may include a griddle or grill and the DR server operates the headset to present a DR GUI across the griddle or grill surface to present visual indications of a plurality of food cooking zones on the surface and further to visually present visual indications of surface temperature and any fluctuations thereon. In still further embodiments, the DR GUI may present counts or prompts of cooked inventory needed, for example to indicate to a cook to prepare more of a cooked food item.

In exemplary embodiments, the DR GUI's are presented to present store operation data that may include customer order data and/or inventory management data. This store operation data may include messages that alert or announce to a store manager or to associated or assigned workers that a food product, for example 1:10 hamburger patties are getting low and either need more to be cooked, or an order for additional inventory updated or made to improve the supply chain. Workers may be prompted with next steps in an order assembly, for example the assembly of a particular sandwich order for a customer, with additional textual, graphical, or other indicative prompts in a DR GUI. This can provide a worker with guidance or reference for order assembly or for loading an order into a carryout bag and to scan the order for correctness and completeness. In one embodiment, the worker may be presented with an image of a sandwich fully assembled in the DR GUI, and then provide a depiction of the next step that the worker must complete to assemble the current ordered sandwich. This may be presented in a DR GUI presented relative to, for example on top of, above, or next a food assembly surface upon which the worker is assembling the customer's sandwich.

In still further exemplary embodiments, the store operation data can include operation metrics or measurements of store efficiency or productivity. In still further exemplary embodiments, the store operation data could be presented along with comparative information representing either additional commonly owned and operated stores or a comparison to store operation data representing a target, model, or optimal store achievement.

In additional exemplary embodiments, the DR GUI's can be tailored to be viewed by works, particular workers, and/or management. In such embodiments, the cognitive burden is tailored to the information needs of particular workers via their headsets and the DR GUI's presented to the worker there through. While a worker may receive the guidance or instructions for the assembly of a food product as described above, a manager may be presented with store operation data in a DR GUI that is presented at a location commonly visible to the manager while working. The store operation data may further include key performance indicators (KPI) of the restaurant and may present those in a comparative fashion to targets or goals, daily, weekly, or yearly benchmarks, or KPI's for other store locations. While not so limited, KPI's that may embody the store operation data may include, but are not limited to, speed of service, kitchen labor hours, food cost, complaint numbers or notices, top and bottom selling food items, basket items, worker productivity, customer count, or ticket size. Persons of ordinary skill in the art will recognize still further KPI's which may be presented in a DR GUI as described.

Citations to a number of references are made herein. The cited references are incorporated by reference herein in their entireties. In the event that there is an inconsistency between a definition of a term in the specification as compared to a definition of the term in a cited reference, the term should be interpreted based on the definition in the specification.

In the above description, certain terms have been used for brevity, clarity, and understanding. No unnecessary limitations are to be inferred therefrom beyond the requirement of the prior art because such terms are used for descriptive purposes and are intended to be broadly construed. The different systems and method steps described herein may be used alone or in combination with other systems and methods. It is to be expected that various equivalents, alternatives, and modifications are possible within the scope of the appended claims.

This written description uses examples to disclose the invention, including the best mode, and also to enable any person skilled in the art to make and use the invention. The patentable scope of the invention is defined by the claims and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A kitchen communication system, the system comprising:
a restaurant internet of things (JOT) system that communicatively connects to a plurality of pieces of food treatment equipment in a kitchen;
a digital reality (DR) server, the DR server operable to store or access stored graphical user interface (GUI) data for each piece of equipment of the plurality of pieces of food treatment equipment, wherein the GUI data comprises a GUI for each of the plurality of pieces of food treatment equipment; and
a DR headset in communicative connection with the DR server, the DR headset operable to project the GUI for each of the plurality of pieces of food treatment equipment in a manner for viewing by a user of the DR headset at a location relative to each of the pieces of food treatment equipment.

2. The kitchen communication system of claim 1, wherein the location relative to each of the pieces of food treatment comprises a position across at least one void in the piece of food treatment equipment.

3. The kitchen communication system of claim 2, wherein the location relative to each of the pieces of food treatment further comprises a position across the at least one void and at least one structure portion of the piece of food treatment equipment.

4. The kitchen communication system of claim 1, wherein each of the GUI for each of the plurality of pieces of food treatment equipment comprises common portions.

5. The kitchen communication system of claim 4, wherein the plurality of pieces of food treatment equipment comprise different configurations of the same equipment type.

6. The kitchen communication system of claim 1, wherein the plurality of pieces of food treatment equipment comprises a refrigerator which comprises at least one camera in an interior of the refrigerator, the refrigerator communicatively connected to the DR server through the restaurant IOT system and the DR server operates the DR headset such that the GUI for the refrigerator presents images of the interior of the refrigerator acquired by the at least one camera.

7. The kitchen communication system of claim 1, wherein the plurality of pieces of food treatment equipment comprises a griddle with a griddle surface and the DR server operates the DR headset such that the GUI for the griddle presents visual indications of a plurality of food cooking zones on the griddle surface and further visually presents an indication of griddle temperature.

8. The kitchen communication system of claim 1, further comprising:
a point of sale system (POS) communicatively connected to the restaurant IOT system wherein the point of sale system receives customer orders, the restaurant IOT system receives and tracks inventory management data from the plurality of pieces of food treatment equipment, and the DR server operates the DR headset such that the GUI for each of the plurality of pieces of food treatment equipment presents customer order data and inventory management data associated with the piece of food treatment equipment.

9. The kitchen communication system of claim 8, wherein the DR server receives the customer orders and operates the DR headset to present a GUI at a specified order assembly location that comprises visual indications of food products required to complete assembly of a customer order of food products.

10. The kitchen communication system of claim 8, wherein the DR server receives the customer orders and operates the DR headset to present a GUI at a specified food assembly location with visual guidance to assembly a particular food product in accordance with the customer orders.

11. The kitchen communication system of claim 1, wherein the DR headset further comprises an infra-red (IR) emitter, and the DR headset measures a temperature of a surface to which the IR emitter is directed and the DR headset presents the measured temperature in a GUI presented by the DR headset associated with the surface to which the IR emitter is directed.

12. The kitchen communication system of claim 1, wherein the DR headset further comprises an ultraviolet (UV) emitter, the DR headset provides a GUI associated with a surface to which the UV emitter is directed, and the DR headset operates the GUI to present an indication of detected reflection of UV light from the UV emitter from the surface.

13. The kitchen communication system of claim 1, wherein the DR headset operates to capture an image of an employee, and the DR headset and DR server operate to identify the employee in the captured image of the employee and the DR headset operates to present a GUI in a location associated with the employee to present employee data in the GUI.

14. The kitchen communication system of claim 13, wherein an RFID tag is associated with the employee, and the DR headset identifies the employee at least in part from a signal from the RFID tag.

15. A method of kitchen communication, the method comprising:
receiving a customer order at a point of sale system;
communicating the customer order from the point of sale system to a restaurant internet of things (IOT) system that is communicatively connected to a plurality of pieces of food treatment equipment in a kitchen;
providing the customer order from the point of sale system to a digital reality (DR) server, the DR server operable to store or access stored graphical user interface (GUI) data for each piece of equipment of the plurality of pieces of food treatment equipment, wherein the GUI data comprises a DR GUI for each of the plurality of pieces of food treatment equipment;
operating a DR headset in communication with the DR server to provide at least a portion of the customer order to the DR headset; and
presenting a DR GUI with the DR headset in an apparent location relative to an associated piece of food treatment equipment, wherein the DR GUI presents at least the portion of the customer order.

16. The method of kitchen communication of claim 15, further comprising:
determining a current inventory of a food product with the associated piece of food treatment equipment;
communicating the current inventory of the food product to the restaurant IOT system;
communicating the current inventory of the food product to the DR headset through the DR server; and
presenting the current inventory of the food product in the DR GUI.

17. The method of kitchen communication of claim 15, further comprising:
capturing an image with a camera associated with the DR headset;
identifying, with the DR server, a piece of food treatment equipment of the plurality of pieces of food treatment equipment in the image; and
selecting the DR GUI from the DR GUIs for each of the plurality of pieces of food treatment equipment based upon the identification of the piece of food treatment equipment in the image.

18. The method of kitchen communication of claim 17, wherein identifying the piece of food treatment equipment further comprises identifying a type of food treatment equipment of the identified piece of food treatment equipment, wherein each DR GUI associated with a piece of food treatment equipment of the same type of food treatment equipment comprises a same DR GUI.

19. The method of kitchen communication of claim 18 wherein the type of food treatment equipment is a holding bin.

20. The method of kitchen communication of claim 17, further comprising:
identifying a void in the piece of food treatment equipment from the image captured with the camera associated with the DR headset; and
wherein the apparent location relative to an associated piece of food treatment equipment is across the identified void in the piece of food treatment equipment.

21. The method of kitchen communication of claim 20, further comprising:
identifying at least one structure portion of the piece of food treatment equipment from the image captured with the camera associated with the DR headset; and
wherein the apparent location relative to the associated piece of food treatment equipment is further across the identified least one structure portion of the piece of food treatment equipment.

22. The method of kitchen communication of claim 15, wherein the DR GUI for each of the plurality of pieces of food treatment equipment comprise at least some common GUI features across all of the DR GUI.

23. The method of kitchen communication of claim 15, wherein the DR GUI is a first DR GUI and further comprising:
presenting at least one second DR GUI with the DR headset in an apparent location relative to a customer interaction, wherein the second DR GUI presents a customer order input interface;
receiving the customer order through the customer order input interface; and
providing the received customer order to the point of sale system.

24. The method of kitchen communication of claim 15, wherein the DR GUI is a first DR GUI and further comprising:
presenting a second DR GUI with the DR headset, wherein the DR headset is associated with a kitchen manager; and
operating the second DR GUI to present store operation data.
